(19) United States
(12) Patent Application Publication
(10) Pub. No.: US 2005/0242221 A1
(43) Pub. Date: Nov. 3, 2005

(54) Two-shaft industrial shredder

(76) Inventor: Fabio Rota, Milan (IT)

Correspondence Address: Chernoff Vilhauer McClung & Stenzel;Attorneys at Law, 1600 Ods Tower, 601 SW Second Avenue, Portland, OR, 97204-3157, US

(21) Appl. No.: 10/521,226

(22) PCT Filed: Jun. 2, 2003
(86) PCT No.: PCT/EP03/05741

§ 371 Date: Jan. 13, 2005

(30) Foreign Application Priority Data
Jul. 26, 2002 (IT) MI2002A001673

(51) Int. Cl. B02C 18/16

(52) U.S. Cl. 241/236

(57) ABSTRACT

An industrial shredder is described—designed to shred the most diverse materials, such as plastic, rubber, paper, wood, metals and the like—which comprises two counter-rotating shafts (1), parallel to each other, whereon are keyed disc-shaped blades (2) with one or more teeth (3), intercalated with spacers (4) having about the same thickness as the blades and a diameter smaller than the blades one, so that the spacers (4) of one shaft are blades and a diameter smaller than the blades one, so that the spacers (4) of one shaft are opposed to the blades (2) of the other shaft, said shafts (1) being so spaced that the blades of one shaft intersect with those of the other shaft to force the material poured into an upper cutting chamber (7) to be sheared between said blades. Beneath said blades (2) hollow supports (14) having a circular profile (15) at the top are provided, connected with which fixed blades (17) are disposed, which cooperate with said blades (2) to perform further cutting of the material already sheared between the opposed blades, said supports (14) extending until they almost come into contact with the spacers (4) of the other shaft to perform cleaning thereof.

The present invention refers to an industrial shredder, designed to shred the most diverse materials, such as plastic, rubber, paper, wood, metal and the like.

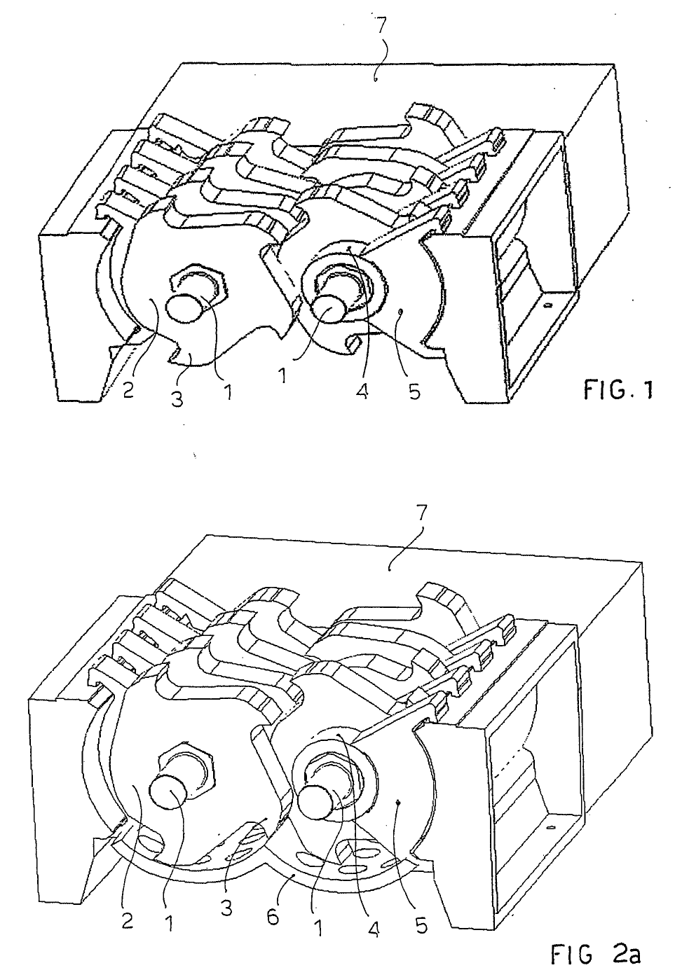

An industrial shredder of the prior art is illustrated in FIG. 1. It is a machine consisting of one or more shafts (1)—in this instance two—parallel to each other and rotating in opposite directions at a speed generally different from each other, whereon disc-shaped blades (2) are keyed provided with one or more teeth (3) which can be of different shapes depending upon the particular use, are formed on the outer profile and are intercalated with round-shaped spacers (4) having about the same thickness as the blades and a smaller diameter smaller than the blades one. The centre distance between the shafts is a little greater than the sum of the radii of the circles circumscribed to spacers and to blades and a little minor than the sum of the radii of the circles tangent upon the base of the teeth, so that the blades of one shaft can intersect with those of the other shaft. The opposite movement of the two shafts causes the material for shredding to be gripped and forced to be sheared to pass between the opposing blades.

After shearing, part of the material falls by gravity beneath the machine and part would be carried back into the upper chamber (called the cutting chamber) because it is trapped between two successive blades of the same shaft: to avoid this effect cleaning sectors (5)—surrounding a part of the circumference of the spacers (4), deflecting all the trapped material downwards and causing it to be discharged downwards—are mounted between the blades.

It has been demonstrated experimentally that if these cleaning sectors are not installed, part of the material carried back into the cutting chamber (7) is shredded again and therefore does not give rise to problems, but part tends to wrap round and clog on the spacers (4) of the faster shaft, gradually forming a layer of compact, extremely hard material, whose thickness increases continually, which causes extremely severe stress between the shafts, causing in a very short time the breaking of the bearings and of other mechanical parts of the machine.

Within certain limits, two of the dimensions of the shredded product—the width and the thickness—are controlled by the thickness of the blades and by the distance of the outer curve of the teeth (3) of the blades from the spacers (4) which are on the opposite shaft, whilst the third dimension (the length of the outgoing pieces) cannot be managed in any way, but rather strips of greater or lesser length, which pass between each blade and the opposite spacer, are typically formed. In many manufacturing processes, the presence of materials in strips can be unacceptable or in any case a nuisance.

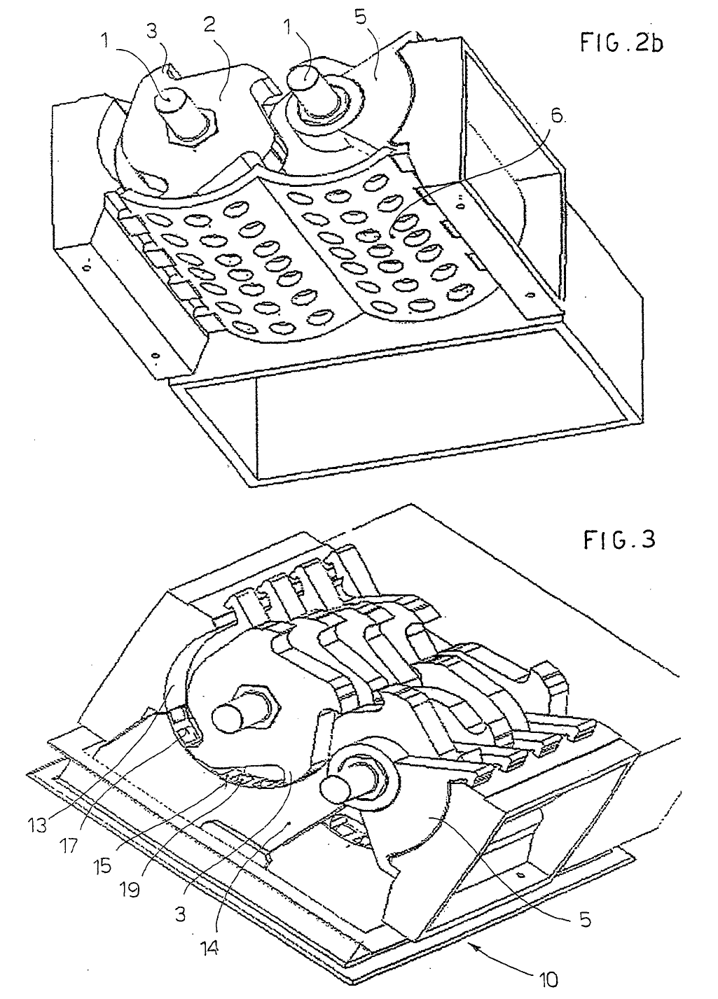

An attempt has been made to obtain a shredding suitable to control all three dimensions for different materials—such as plastic, wood, paper, metal shavings or others—by using shredders with only two shafts (with three or more shafts this is normal, but these machines are considerably more complex and expensive), by installing screens (6)—see FIGS. 2a and 2b—that surround the outer curve of the blades (2) at the bottom: in this manner only materials of a sufficiently small size can pass through the screen holes and can be discharged.

However, it was immediately found that with this solution the cleaning sectors (5) cannot be left mounted because the materials they force to descend downwards remain blocked against the screens and, after a short time, exert such a pressure thereon as to destroy them: on the other hand, if the sectors (5) are removed, the previously described drawbacks occur on an increased way on the spacers of the faster shaft.

An object of the present invention is to provide an industrial shredder with two shafts of the above type that allows to control of all three dimensions of the materials shredded, overcoming the described above drawbacks.

Another object of the invention is to provide a shredder that is extremely reliable, of simple design and therefore cheap to make.

Yet another object of the invention is to provide a shredder that does not present substantial structural differences from the existing shredders and which, therefore, might even be obtained with slight modifications of the existing ones.

These objects are achieved by the shredder according to the invention, which has the characteristics of appended independent claim 1.

Advantageous embodiments of the invention are apparent from the dependent claims. Essentially, according to the invention, groups of fixed blades are added which, by surrounding the circumference of the blades mounted on each shaft, allow a further cutting and shredding stage on the material already sheared between the opposing blades of the rotors in the cutting chamber and—by almost scraping against the spacers correspondingly keyed onto the opposite shaft—keep them clean and prevent the formation of any progressive build-up of material on said spacers. Another achievement in practice is that by choosing an adequate number of fixed blades and spacing them in an orderly manner on their support along the circumference of the blades, the fixed blades themselves create a kind of selection screen that allows the passage only of pieces of an acceptable size, whilst the others are carried back into the cutting chamber where they are further sheared, until the desired sizes are obtained.

Further characteristics of the invention will be apparent from the detailed description that follows, referring to a purely exemplary and therefore non limiting embodiment thereof, illustrated in the appended drawings, in which:

FIG. 1 is a perspective view of an industrial shredder according to the prior art, provided with cleaning sectors;

FIGS. 2a and 2b are perspective views, taken from different angles, of a shredder of the prior art, provided with cleaning sectors and bottom screens;

FIG. 3 is a perspective view of an industrial shredder according to the invention;

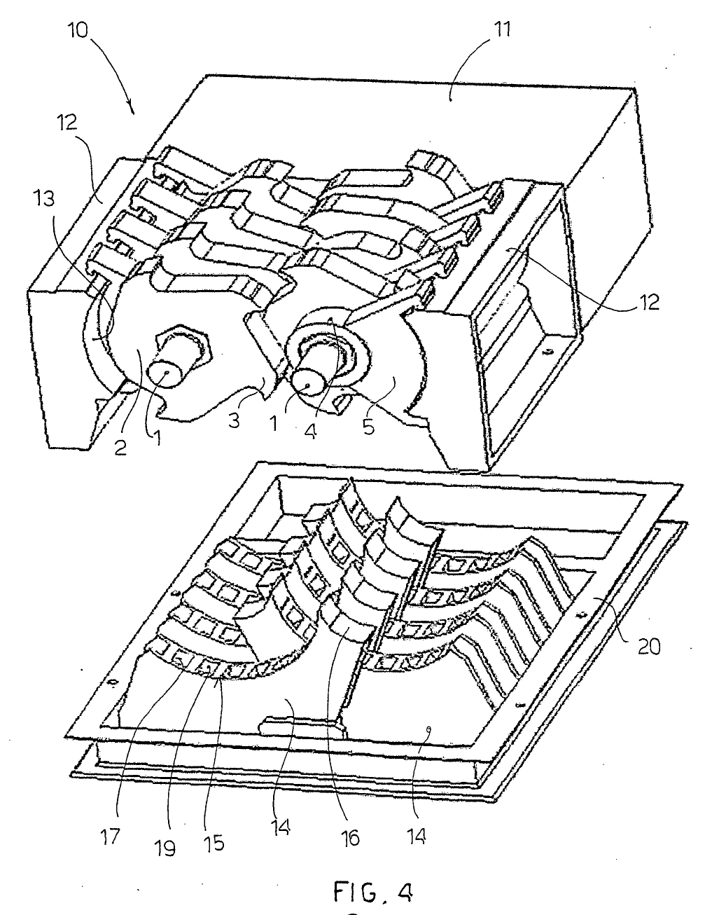

FIG. 4 is an exploded view of the shredder of FIG. 3;

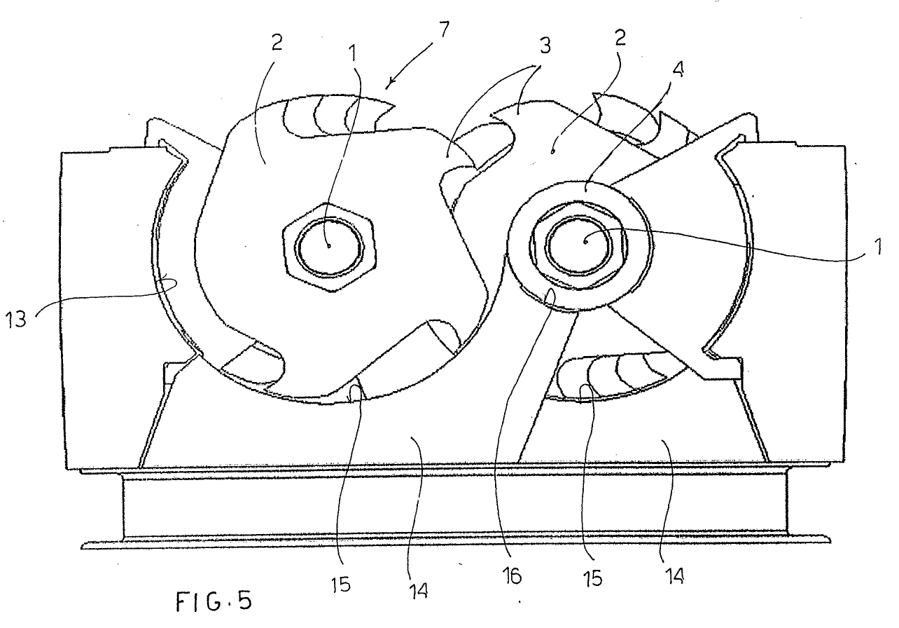

FIG. 5 is a front view of the shredder of FIG. 3;

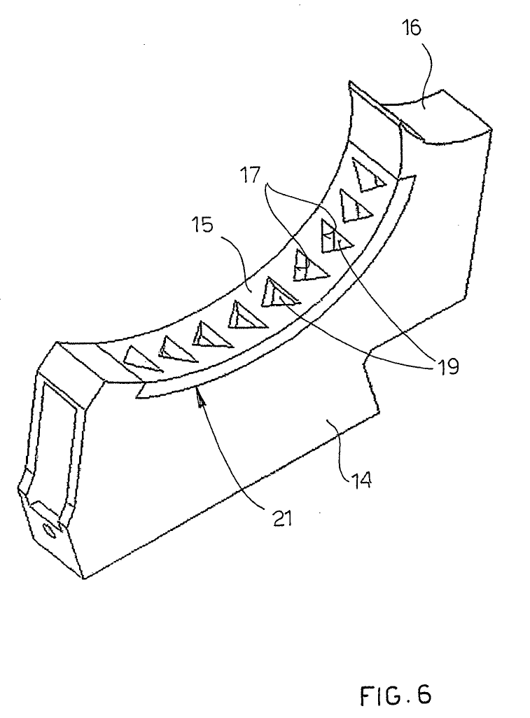

FIG. 6 is a perspective view of a particular shredder according to the invention, showing a different shape of the fixed blades.

In the description that follows of the industrial shredder according to the invention, shown in FIGS. 3 to 6, a detailed description of the parts already described in the preamble with reference to the prior art (FIGS. 1, 2a, 2b) will be omitted since said parts remain substantially unchanged and will be simply recalled with the same reference numerals already used.

In FIGS. 3 to 5, illustrating the shredder for plastic, wood, paper, metal shavings and the like, according to the invention, denoted as a whole with reference numeral 10, the two shafts 1 can be seen, whereon are keyed the disc-shaped blades 2 having on their outer profile one or a plurality of teeth 3, the circular-shaped spacers 4 and the upper cutting chamber 7. Also shown are the cleaning sectors 5 which however, in the device according to the invention, serve to retain the material in the cutting chamber 7 in the event of reversal of the direction of rotation of the blades, which is sometimes necessary during shredder operation.

The shafts 1 are supported by end blocks 11, only one of which is shown in FIG. 4, whilst longitudinally and externally thereto there are provided two side walls 12, having on the inside a circular profile 13 along which the teeth 3 of the blades 2 slide. Also mounted on the side walls 3 [12; Translator note] are said cleaning sectors 5, which are substantially shaped as sectors of annulus, with an outside radius about equal to the radius of said circular profile 13 of the side walls and an inside radius little greater than the radius of the spacers 4.

An essential feature of the invention is that beneath each blade 2 and corresponding spacer 4, there is provided a hollow element or support 14, having at the top a cradleshaped seat 15 with a substantially circular profile which joins the bottom edge of the inside circular profile 13 of the corresponding side wall 12 to the opposing spacer 4, coinciding with which the support 15 [14; Translator note] has a further circular profile 16 with a smaller extension with respect to the profile 15, which adapts perfectly to the profile of the spacer 4, almost scraping on it.

In the cradle-type seat with a circular profile 15 of the support 14, there is provided at least one and preferably a plurality of fixed blades 17, which cooperate with the teeth 3 of the corresponding blade 2 to make a further cut on the material already sheared between the opposed blades 2 of the rotor shafts 1 in the cutting chamber 7. The fixed blades 17 can be formed by making apertures 19 in the circular profile 15, in the specific case rectangular in shape, possibly with cutting edges. The material is cut against them by the teeth 3 of the blades 2, passing through the apertures 19 and the hollow support 14 and falling there under. Of course, pieces of a size larger than the apertures 19 cannot pass there through and are returned to the upper cutting chamber 7 by the teeth 3 which pull them along the circular profiles 15 and 13. Said pieces are further sheared until the desired dimensions are obtained.

The circular profile 16 of the support 14 that, as stated, comes to be disposed almost in contact with a corresponding spacer 4, prevents the passage of the material and thus the formation of any gradual build-up of material on the spacer, keeping it perfectly clean.

The presence of the cleaning sectors 5 in the shredder according to the invention, as stated previously, serves solely to retain the material in the cutting chamber 7 in the event of reversal of the direction of rotation of the blades.

The fixed blades 17 and the corresponding apertures 19, which can be disposed in an adequate number and at the desired distance on the respective supports 14 along the circumference of the respective blades 2, create a sort of selection screen which allows the passage of pieces of the desired size.

The fixed blades 17 can be of any shape, according to the pieces of material that are to be obtained. Purely by way of example, in FIG. 6 V-shaped blades are shown, again denoted by reference numeral 17, associated with triangular-shaped apertures 19.

The fixed blades 17 are preferably disposed at a very short distance from the teeth 3 of the blades 2 (for example 0.5-5 millimeters), according to the nature of the material to be processed.

The supports 14 of the fixed blades are advantageously mounted on a frame 20, as can be seen in FIGS. 3, 4 and 5, in a fixed or removable manner. Said supports 14 can advantageously be mounted adjustably, so as to be able to adjust the distance between the fixed blades 17 and the teeth 3 of the blades 2, also to compensate for the wear on said teeth. The fixed blades 17 and the respective openings 19 can be formed directly on the supports 14 or on strips of sheet metal 21, as shown diagrammatically in FIG. 6, which are subsequently constrained to the supports 14.

Naturally, provision is made for the fixed blades or the entire support containing them to be replaced when the blades are worn.

The advantages of the industrial shredder according to the invention are evident from the foregoing in that thanks to the provision of the supports 14 with fixed blades 17 cooperating with the blades 2 and to the circular profiles 16 abutting against the spacers 4, all three dimensions of the materials processed—and in particular the length of the strips which are sheared between the blades 2—can be controlled. The desired measurements of the cut pieces can easily be controlled by appropriately choosing shape, dimensions and distance of the fixed blades 17 and of the corresponding apertures 19.

In the foregoing, the inside profiles 13 of the side walls 12 of the machine have been described as circular; the invention nevertheless also applies to the case in which said profiles 13 are of a different shape, for example flat.

Of course, the invention is not limited to the particular embodiment described above and illustrated in the appended drawings, but numerous modifications of detail within the reach of a person skilled in the art can be made thereto, without thereby departing from the scope of the invention, as set forth in the appended claims.

1. An industrial shredder, designed to shred materials such as plastic, wood, rubber, paper, metals and the like, comprising two counter-rotating shafts (1) parallel to each other, whereon disc-shaped blades (2) having on their profile one or more teeth (3), intercalated with spacers (4) with a thickness equal to that of the blades and a diameter smaller than that of the blades, are keyed so that the spacers (4) of one shaft are opposed to the blades (2) of the other shaft, said shafts (1) being disposed at such a distance that the blades (2) of one shaft (1) intersect with those of the other shaft to force the material poured into an upper cutting chamber (7) to be sheared between said blades, characterised in that, beneath at least one blade (2) a hollow support (14) is provided, which has at the top a circular profile (15) coinciding with which is disposed at least one fixed blade (17) associated with an aperture (19) and cooperating with said blade (2) to perform further cutting of the material already sheared between the opposing blades, said support (14) extending to come almost into contact with the spacer (4) opposite said blade (2) to carry out cleaning of said spacer and avoid build-up of material thereon.

2. A shredder according to claim 1, characterised in that said circular profile (15) is a substantially circular profile which surrounds the circumference of the corresponding blade (2) and is joined, on one side, to a profile (13) formed on the inside of a respective side wall (12) of the shredder and, on the other side, to the spacer (4) situated opposite said blade (2).

3. A shredder according to claim 2, characterised in that said profile (13) inside the side wall (12) is circular.

4. A shredder according to any one of the preceding claims, characterised in that said circular profile (15) continues, on the side of the spacer (4), with a further circular profile (16), which wraps partially round said spacer.

5. A shredder according to any one of the preceding claims, characterised in that a support (14) is provided beneath each blade (2) of each shaft (1).

6. A shredder according to any one of the preceding claims, characterised in that each support (14) is provided with a plurality of fixed blades (17) and of respective apertures (19), whose shape, size and reciprocal distance are chosen according to the material and to the dimensions of the cut pieces.

7. A shredder according to any one of the preceding claims, characterised in that said fixed blades (17) consist of apertures, possibly with cutting edges, of said apertures (19) formed in said circular profile (15) of the support (14).

8. A shredder according to any one of the preceding claims, characterised in that said apertures (17) are rectangular, square, triangular, round, diamond-shaped or the like.

9. A shredder according to any one of the preceding claims, characterised in that said fixed blades (17) are disposed at a very short distance from the teeth (3) of the blades (2), for example 0.5-5 millimeters.

10. A shredder according to any one of the preceding claims, characterised in that said supports (14) are fixed, removable or openable.

11. A shredder according to any one of the preceding claims, characterised in that said supports (14) and/or said fixed blades (17) can be positioned at an adjustable distance from the teeth (3) of the blades (2).

12. A shredder according to any one of the preceding claims, characterised in that said fixed blades (17) and apertures (19) are formed on strips of sheet metal constrained to said supports (14).

13. A shredder according to any one of the preceding claims, characterised in that between said blades (2) of each shaft (1) are intercalated sectors (5), which surround the circumference of the corresponding spacers (4).
